(19) United States
(12) Patent Application Publication
(10) Pub. No.: US 2005/0165189 A1
(43) Pub. Date: Jul. 28, 2005

(54) Semi-crystalline polymer compositions with mixed comonomers

(76) Inventors: Periagaram S. Ravishankar, Kingwood, TX (US); Kent L. Chasey, Houston, TX (US)

Correspondence Address: ExxonMobil Chemical Company;Law Technology, P.O. Box 2149, Baytown, TX, 77522-2149, US

(21) Appl. No.: 11/032,819

(22) Filed: Jan. 11, 2005

(51) Int. Cl. C08F 10/00

(52) U.S. Cl. 526/282; 526/336; 428/36.8; 524/554

(57) ABSTRACT

An elastomer comprising units derived from ethylene, a higher alpha-olefin having from 3 to 10 carbon atoms and a diene having a Mooney ML (1+4) 125° C. of from 20 to 120 and an ethylene content of from 40 to 80 wt % and a diene content of from 0.5 to 10 wt % is disclosed herein. The higher alpha-olefin forms the balance, wherein from 60 mol % to 100 mol % of the units derived from the higher alpha-olefin comprises units derived from 1-octene.

### BACKGROUND INFORMATION

Copolymers that combine one or more comonomers are well known in the art and commercial practice. Some examples of these are Ethylene-Propylene (EPM), Ethylene-Propylene-Diene (EPDM) and Ethylene-Octene (EO) polymers. Ziegler-Natta catalysts are commonly used to produce only EPM and EPDM polymers since they do not readily copolymerize higher alpha-olefins. The advent of metallocene based catalysts has facilitated the synthesis of ethylene-higher alpha olefin copolymers. These polymers up to now have typically been “plastic like” polymers, replacing and sharing the attributes of low-density plastics.

Copolymerization with dienes such as ENB and increasing the molecular weight (Mooney viscosity) allows the production of “rubber like” molecules with unique properties. However, a simple replacement of comonomer type at constant ethylene content results in a one-dimensional change in properties without a method of adjusting those properties to the desired level of balance.

WO200026268 attributes higher green strength to the presence of long chain branching. Other references of interest include U.S. Pat. No. 5,696,213, U.S. Pat. No. 6,410,650, U.S. Pat. No. 5,610,254, U.S. Pat. No. 5,922,823, EP1016689 and U.S. 2003096912, all of which are incorporated herein by reference.

### SUMMARY OF THE INVENTION

The invention firstly provides an elastomer comprising units derived from ethylene, a higher alpha-olefin having from 3 to 10 carbon atoms and a diene having a Mooney ML (1+4) 125° C. of from 20 to 120 and an ethylene content of from 40 to 80 wt % and a diene content of from 0.5 to 10 wt %, said higher alpha-olefin forming the balance, wherein at least 60 mol % of said units derived from said higher alpha-olefin comprises units derived from 1-octene.

Preferably at least 90 mol % of said units derived from a higher alpha-olefin are units derived from 1-octene. Suitably the diene is ethylidene vinylnorbornene (ENB), preferably in an amount of from 2 to 8 wt %. The elastomer may contain a transition metal residue other than vanadium from residual catalyst and optionally contains boron metal residue from a non-coordinating activator for the catalyst.

The polymer in which the propylene is replaced with octene at equivalent weight basis of the comonomer provides a higher green strength in comparison to the polymer made with propylene derived units. The polymer may have substantially higher modulus at 50% strain and stress at yield. The inventive polymer may have a higher modulus and lower elongation at break. The heat aging properties may be similar and the high temperature compression set may be improved.

Yet further optimization of the properties can be achieved when the polymer contains fractions from different polymerization stages having a molecular weights that differ by at least 10 Mooney units and/or differ by at least 5 wt % in units derived from the higher alpha olefin.

The polymer of the invention may be used in a formulation for an industrial hose comprising from 10 to 30 wt % of the elastomer and from 40 to 80 wt % of fillers.

The bimodal composition and molecular weight made using two reactors in series can alter the properties of an EODM polymer made in a single reactor. A better balance of desired properties in the polymer such as green strength and elongation at break may be achieved.

While the invention is illustrated with a particular catalyst system, the catalyst system may be optimized to permit higher process temperatures and/or higher molecular weights. For example the catalyst may employ the fluorenyl cyclopentadienyl type of hafnocene described in EP351391, a mono cyclopentadienyl metallocene as described in EP416815 or variants thereof using different types of hetero-atom substituted on the transition metal atom or pyridine amine types as described in WO02/040201. The activation system is generally of the type described in U.S. Pat. No. 5,599,761 but alumoxane type activators may be used as well. Catalysts systems may use a combination of these as in WO99/41294 or WO99/45040. All these are incorporated by reference.

### EXAMPLE

A Continuous Flow Stirred Tank Reactor(s) is used with Rx 1 and Rx 2 in series configuration, using a catalyst system with dimethyl-silyl-bis(indenyl) hafnium dichloride activated by the dimethyl anilinium salt of tetrakis(pentafluorophenyl) borate. The reactor conditions are shown in Table 1 for the single reactor configuration and Table 2 for the two reactors-in-series configuration. All polymers were formulated in a highly filled (734 phr) industrial hose compound as shown in Table 3. The green strength (stress-strain data) of the compounds made with the inventive and comparative polymers are shown in Table 4.

The series reactor product has substantially lower modulus at 50% strain and stress at yield. The cure behavior and properties of vulcanized compounds are also shown in Table 4. While the cure rate and state appear substantially equivalent, the series reactor polymer has higher elongation at break than the single reactor product. The heat aging properties and the high temperature compression are similar to the single reactor product. Thus a balance of properties has been achieved with the dual reactor polymer, not as easily available with the single reactor polymer. The catalyst system may be varies to allow further variations in the properties.

TABLE 1
(single reactor)

| Process feature | Unit | Value in Reactor (Rx) |
|---|---|---|
| Scavenger tri-n-octyl | ml/mm | 23 |
| aluminum | | |
| Residence time in Rx | min | 11.9 |
| Rx Temperature | ° C | 51 |
| Hydrogen addition | ppm/C2 | 0 |
| Catalyst efficiency | g M1/g polymer | 4275 |
| C2 conversion | % | 57 |
| Ethylidenevinylnorbornene | % | 33 |
| conversion | | |
| 1-Octene conversion | % | 40 |
| Polyrate | kg/hour | 1.160 |

The polymer has an ML (1+4) 125° C. of 66, an ethylene content of 72 wt % and an ENB content of 5.1 wt %.

TABLE 2
(dual reactors in series)

| | | Value in Rx 1 | Value in Rx 2 |
|---|---|---|---|
| Process feature | Unit | (upstream) | (downstream) |
| Residence time | Mm | 9.7 | 9 |
| Rx Temperature | C | 35 | 37 |
| Hydrogen addition | | 0 | 0 |
| Ethylene conversion | % | 59 | 79 |
| Ethylidenevinylnorbornene | % | 34 | 56 |
| conversion | | | |
| 1-octene conversion | % | 30 | 62 |
| Polyrate | kg/hour | 0.938 | 2.063 |
| Cement concentration | % | 2.62 | |
| Polysplit | % | 45 | 55 |

The polymer has an ML (1+4) 125° C. of 60, an ethylene content of 70 wt % and an ENB content of 4.6 wt %.

The EPDM type polymer comparable in composition with that in Table 1 r has an ML (1+4) 125° C. of 58, an ethylene content of 73 wt % and an ENB content of 4.9 wt %.

TABLE 3
Formulation

| Formulation ingredient | units are phr |
|---|---|
| E-O-ENB or EP-ENB | 100 |
| N550 black | 100 |
| N762 black | 180 |
| Allied whiting | 150 |
| Hyprene 2000 | 190 |
| Zinc Oxide | 4.0 |
| Stearic acid | 1.5 |
| Sulfur | 2.0 |
| MBTS | 2.5 |
| Vocol S | 4.0 |
| Total phr | 734 |
| Wt % E-O-DM | 13.6 |
| Specific gravity | 1.34 |

TABLE 4
performance comparison

| | Formulation with | Formulation with | Formulation with |
|---|---|---|---|
| Feature | Vistalon 7000 | E-O-DM (Series) | E-O-DM (Single) |
| 50% strain green strength | 0.60 | 1.0 | 1.32 |
| molded pad 100° C., 3 min | | | |
| Yield green strength | 2.28 | 2.91 | 3.76 |
| molded pad 100° C., 3 min | | | |
| Mooney (ML) 100° C. | 36 | 27 | 34 |
| (1 + 8), min | | | |
| Mooney Scorch (MS) | 14 | 16 | 18 |
| 132° C. | | | |
| t3, min | | | |
| Mooney Scorch (MS) | 17 | 19 | 21 |
| 132° C. t10, min | | | |
| ODR, 160° C. 3° arc 60 min | | | |
| Mₗ | 2.2 | 1.9 | 3.2 |
| Mₕ | 44.0 | 35.9 | 40.0 |
| Mₕ-Mₗ | 41.8 | 84 | 36.8 |
| tS2, min | 3.2 | 3.3 | 3.3 |
| tS5, min | 3.8 | 4.0 | 3.9 |
| t′90 min | 21.2 | 21.4 | 20.4 |
| t′98 min | 33.4 | 33.6 | 32.0 |
| Rate lbf-in/min | 10 | 8 | 8 |
| Press Cure 160 C. 40 min | | | |
| Hardness Shore A | 78 | 82 | 84 |
| 100% Modulus MPa | 3.0 | 3.6 | 4.1 |
| 200% Modulus MPa | 5.4 | 5.7 | |
| Tensile Strength MPa | 6.1 | 5.9 | 6.2 |
| Elongation at break % | 250 | 215 | ??? |
| Heat age Air oven 125° C. | | | |
| 70 hr | | | |
| Hardness change points | +7 | +11 | 0 |
| Tensile Strength MPa | 7.2 | 7.2 | 7.4 |
| Tensile Strength change % | +18 | +13 | +20 |
| Elongation at break % | 120 | 90 | 90 |
| Elongation at break change % | −52 | −59 | −52 |
| Compression Set extruded | | | |
| button | | | |
| Press cure 160° C. 45 min | 84 | 76 | 75 |

1. An elastomer comprising units derived from ethylene, a higher alpha-olefin having from 3 to 10 carbon atoms and a diene having a Mooney ML (1+4) 125° C. of from 20 to 120 and an ethylene content of from 40 to 80 wt % and a diene content of from 0.5 to 10 wt %, said higher alpha-olefin forming the balance, wherein from 60 mol % to 100 mol % of said units derived from said higher alpha-olefin comprises units derived from 1-octene.

2. An elastomer according to claim 1 in which the polymer comprises from 90 mol % to 100 mol % of said units derived from a higher alpha-olefin are units derived from 1-octene.

3. An elastomer according to claim 1 in which the diene is ethylidene vinylnorbornene (ENB), preferably in an amount of from 2 to 8 wt %.

4. An elastomer according to claim 2 in which the diene is ethylidene vinylnorbornene (ENB), preferably in an amount of from 2 to 8 wt %.

5. An elastomer according to claim 1 in which the elastomer contains a transition metal residue other than vanadium from residual catalyst and optionally contains boron metal residue from an activator for the catalyst.

6. An elastomer according to claim 2 in which the elastomer contains a transition metal residue other than vanadium from residual catalyst and optionally contains boron metal residue from an activator for the catalyst.

7. An elastomer according to claim 3 in which the elastomer contains a transition metal residue other than vanadium from residual catalyst and optionally contains boron metal residue from an activator for the catalyst.

8. An elastomer according to claim 4 in which the elastomer contains a transition metal residue other than vanadium from residual catalyst and optionally contains boron metal residue from an activator for the catalyst.

9. An elastomer according to claim 1 in which the polymer contains fractions from different polymerization stages having a molecular weights that differ by at least 10 Mooney units and/or differ by at least 5 wt % in units derived from the higher alpha olefin.

10. An elastomer according to claim 2 in which the polymer contains fractions from different polymerization stages having a molecular weights that differ by at least 10 Mooney units and/or differ by at least 5 wt % in units derived from the higher alpha olefin.

11. An elastomer according claim 3 in which the polymer contains fractions from different polymerization stages having a molecular weights that differ by at least 10 Mooney units and/or differ by at least 5 wt % in units derived from the higher alpha olefin.

12. A formulation for an industrial hose comprising from 10 to 30 wt % of an elastomer according to claim 1 and from 40 to 80 wt % of fillers.

13. A formulation for an industrial hose comprising from 10 to 30 wt % of an elastomer according to claim 2 and from 40 to 80 wt % of fillers.

14. A formulation for an industrial hose comprising from 10 to 30 wt % of an elastomer according to claim 3 and from 40 to 80 wt % of fillers.

15. A formulation for an industrial hose comprising from 10 to 30 wt % of an elastomer according to claim 9 and from 40 to 80 wt % of fillers.

16. A formulation for an industrial hose comprising from 10 to 30 wt % of an elastomer according to claim 10 and from 40 to 80 wt % of fillers.

17. A formulation for an industrial hose comprising from 10 to 30 wt % of an elastomer according to claim 11 and from 40 to 80 wt % of fillers.

18. An industrial hose made from a cured formulation according to claim 12.

19. An industrial hose made from a cured formulation according to claim 13.

20. An industrial hose made from a cured formulation according to claim 14.

21. An industrial hose made from a cured formulation according to claim 17.
